(19) United States
(12) Patent Application Publication
(10) Pub. No.: US 2022/0300760 A1
(43) Pub. Date: Sep. 22, 2022

(54) MACHINE LEARNING-BASED RECOMMENDATION SYSTEM

(71) Applicant: SAP SE, Walldorf (DE)

(72) Inventors: Shruti BHARGAVA, Palo Alto, CA (US); Ran ZHOU, Palo Alto, CA (US); Tanya PIPLANI, Cupertino, CA (US); Varsha SANKAR, Palo Alto, CA (US); Qing DU, Palo Alto, CA (US); Bharath SIVARAMAN, Santa Clara, CA (US); Fuming WU, Palo Alto, CA (US); KeQiang XIONG, Shenzhen (CN)

(21) Appl. No.: 17/205,218

(22) Filed: Mar. 18, 2021

(51) Int. Cl. G06K 9/62; G06N 20/00; G06Q 30/02

(52) U.S. Cl. CPC G06K 9/6256; G06N 20/00; G06Q 30/0282

(57) ABSTRACT

Systems and methods include determination of a plurality of records, each of the plurality of records including an event, an item, a supplier, and a timestamp, generation, for each of the plurality of records, of a negative sample record including the event of the record, the item of the record, the timestamp of the record, and a sample supplier different from the supplier of the record, association of each of the plurality of records and the generated negative sample records with either a first time period or a second time period based on the timestamp of the record, training of a machine-learning model based on the records and the negative sample records associated with the first time period, and evaluation of the trained model based on the records and the negative sample records associated with the second time period.

### BACKGROUND

Modern software applications enable efficient execution of tasks. Such tasks may include generation of data records including but not limited to sales orders, procurement orders, shipment instructions, etc. Software applications may access and utilize historical data records to facilitate generation of new data records. For example, software applications may pre-fill certain fields or provide a menu of possible field values based on values present in historical data records.

Recommender systems provide logic for assisting user generation of certain data records. For example, a recommender system may analyze historic data records to suggest field values or other data records based on prior user preferences. Types of recommender systems include collaborative filtering, content-based and hybrid systems.

Enterprise procurement involves significant manual effort and subject matter expertise and is therefore both time- and resource-intensive. Procurement-specific recommendation systems present unique challenges such as domain-specific jargon, abbreviations, multilingual data, generalization across customers, and timeliness requirements. Systems are desired to facilitate procurement processes via efficient recommendations.

### BRIEF DESCRIPTION OF THE DRAWINGS

FIG. 1 is a block diagram of an architecture to provide supplier recommendations according to some embodiments.

FIGS. 2A and 2B comprise a flow diagram of a process to train and deploy a neural network to provide supplier recommendations according to some embodiments.

FIG. 3A is a tabular representation of training data records according to some embodiments.

FIG. 3B is a tabular representation of training data records including negative samples according to some embodiments.

FIG. 4 is a block diagram of an architecture to train a neural network to infer supplier recommendations according to some embodiments.

FIG. 5 is a diagram of a neural network architecture according to some embodiments.

FIG. 6 illustrates a user interface of a sourcing application according to some embodiments.

FIG. 7 illustrates a user interface of a sourcing application according to some embodiments.

FIG. 8 illustrates a user interface of a sourcing application providing supplier recommendations according to some embodiments.

FIG. 9 illustrates a user interface of a sourcing application according to some embodiments.

FIG. 10 is a block diagram of a hardware system for providing supplier recommendations according to some embodiments.

### DETAILED DESCRIPTION

The following description is provided to enable any person in the art to make and use the described embodiments and sets forth the best mode contemplated for carrying out some embodiments. Various modifications, however, will be readily-apparent to those in the art.

Some embodiments relate to systems such as procurement systems in which a user identifies items and determines one or more suppliers to supply the items. Embodiments may operate to train a neural network model to recommend suppliers for a given item. The model may be trained based on historical data to learn item-supplier patterns through the surrogate task of binary classification. Embodiments may operate to generate candidate suppliers as well as a subset of recommended suppliers. Embodiments may further provide the user with one or more reasons why a given supplier has been recommended for a given item.

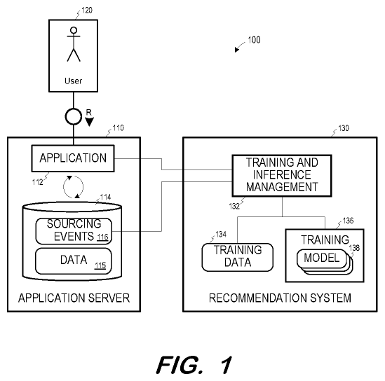

FIG. 1 is a block diagram of an architecture of system 100 according to some embodiments. The illustrated elements of system 100 may be implemented using any suitable combination of computing hardware and/or software that is or becomes known. In some embodiments, two or more elements of system 100 are implemented by a single computing device. Two or more elements of system 100 may be co-located. One or more elements of system 100 may be implemented as a cloud service (e.g., Software-as-a-Service, Platform-as-a-Service). A cloud-based implementation of any elements of system 100 may apportion computing resources elastically according to demand, need, price, and/or any other metric.

Application server 110 may comprise an on-premise or cloud-based server providing an execution platform and services to applications such as application 112. Application 112 may comprise program code executable by a processing unit to provide functions to users such as user 120 based on logic and on data stored in data store 114. Data store 114 may comprise any suitable storage system such as a database system, which may be partially or fully remote from application server 110, and may be distributed as is known in the art.

Application 112 may create, read, update and delete data of data store 114 based on a data schema consisting of semantic objects as is known in the art. For instance, data store 114 may store relational database tables and views whose columns conform to a data schema defined by metadata also stored in data store 114. The data of object instances of a given semantic object may be stored in a same one or more database tables specified by the metadata.

Data store 114 stores data 115. Data 115 may conform to any one or more data formats and may be associated with one or more applications executing on application server 110, including but not limited to application 112. Data 115 may be column-based, row-based, object data or any other type of data that is or becomes known.

Application 112 may be operable by user 120 to execute procurement-related functions in some embodiments. Application 112, which may consist of several interoperating applications and/or microservices, may be executed to allow a user to defined required items and initiate processes for procuring the items. The items may comprise finished products, component parts to be used for assembling a product, tools, services, and/or any other tangible or intangible unit which may be procured from a supplier.

According to some embodiments, user 120 may interact with application 112 (e.g., via a Web browser executing a client application associated with application 112) to define a “sourcing event”. A sourcing event may comprise an event type (e.g., Request for Proposal, Auction) and one or more items associated with the event. The sourcing event may further specify parameters such as number of units, delivery timeframe, quality level, payment terms, cost range, commodity code, region code, department code, etc.

Each item of a sourcing event may be associated with one or more suppliers. Application 112 may allow a user to select one or more suppliers from a list of potential suppliers. The list may be specific to the item but embodiments are not limited thereto. As will be described in detail below, some embodiments train and deploy a neural network model to provide one or more recommended suppliers to user 120 for a given item of a sourcing event. User 120 may select zero, one or more of the recommended suppliers to associate with the given item. According to some embodiments, data indicating user selection (and/or non-selection) of a supplier may be stored in conjunction with the sourcing event and used during subsequent retraining of the model.

In this regard, data store 114 also stores data of sourcing events 116. For purposes of the present description, sourcing events 116 comprise data specifying, for each sourcing event defined therein, an event, one or more items associated with the event, attributes associated with the event, attributes associated with the one or more items, a creation timestamp, and one or more invited suppliers. It should be noted that a sourcing event of sourcing events 116 may be associated with many other data fields (e.g., accepting suppliers, recommended suppliers, creating user) according to some embodiments.

During execution, and possibly in response to a request initiated by user 120, application 112 may call training and inference management component 132 of recommendation system 130 to request training of a model to generate supplier recommendations according to some embodiments. Application 112 may also call training and inference management component 132 of recommendation system 130 to request supplier recommendations inferred by an already-trained model based on a given event-item pair.

In response to the former, training and inference management component 132 may receive data of sourcing events 116 from application server 110. Training and inference management component 132 may pre-process and/or generate additional data based on the received data to generate training data 134 as will be described below. Training data 134 is used by training component 136 to train one of models 138 as is known in the art. The trained model 138 may comprise a binary classifier which determines, for each of several possible suppliers, a probability that the supplier will be selected for a particular event-item pair of a sourcing event.

Training component 136 may stores a plurality of models 138 having different structures (i.e., hyperparameter values), initial node weights, and/or objective functions. For example, some of models 138 may be associated with certain customers and other ones of models 138 may be associated with other customers. An instruction received from training and inference management system 132 to train a model may therefore identify a particular customer requesting the training, and this identification is used to determine which of models 138 to train.

In response to receiving an inference request specifying a given event-item pair, training and inference management component 132 inputs the event-item pair to a suitable one of models 138. Based on the pair, the model 138 generates several candidate suppliers which are associated with similar event-item pairs in the historical data and then outputs a probability, for each of the candidate suppliers, that the supplier will be associated with a particular event-item pair of a sourcing event. The probabilities are returned to application 112 and application 112 may present one or more of the suppliers (e.g., only those suppliers associated with a probability greater than a threshold value) to user 120. As will be described below, the suppliers may be filtered based on the associated probabilities and on any other attribute prior to being presented to user 120 as recommended suppliers.

User 120 may select any of the recommended suppliers for association with a sourcing event. The selection may be recorded in sourcing events 116 and used to retrain the model 138 as desired at a later date.

In some embodiments, application 112 and training and inference management system 132 may comprise a single system, and/or application server 110 and recommendation system 130 may comprise a single system. In some embodiments, recommendation system 130 supports model training and inference for applications other than application 112 and/or application servers other than application server 110.

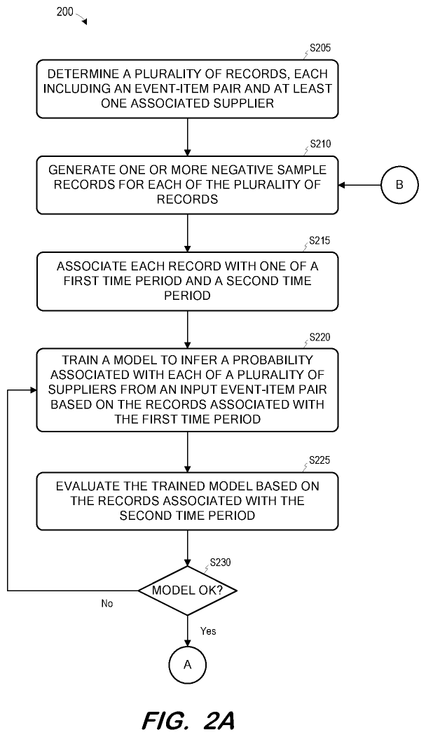

FIGS. 2A and 2B comprise a flow diagram of process 200 to train and deploy a neural network to provide supplier recommendations according to some embodiments. Process 200 will be described with respect to the elements of system 100, but embodiments are not limited thereto.

Process 200 and all other processes mentioned herein may be embodied in processor-executable program code read from one or more of non-transitory computer-readable media, such as, for example, a hard disk drive, a volatile or non-volatile random access memory, a DVD-ROM, a Flash drive, and a magnetic tape, and then stored in a compressed, uncompiled and/or encrypted format. A processor may include any number of microprocessors, microprocessor cores, processing threads, or the like. In some embodiments, hard-wired circuitry may be used in place of, or in combination with, program code for implementation of processes according to some embodiments. Embodiments are therefore not limited to any specific combination of hardware and software.

Process 200 may be triggered by a request to train a model to generate supplier recommendations. The request may be received from user 120 via application 112. In some embodiments, a technical administrator of recommendation system 130 submits a request to training and inference management component 132.

In response to the request, training and inference management component 132 may acquire records of sourcing events 116 at S205. The records may include any suitable fields which are or become known. The acquired records may comprise fields of one or more database tables. In this regard, the acquired records need not necessarily be instantiated within sourcing events 116 or data 115, but may be generated on-the-fly during S205.

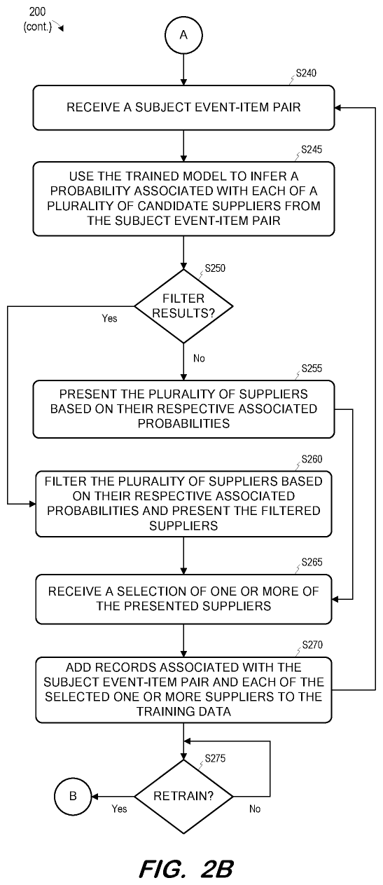

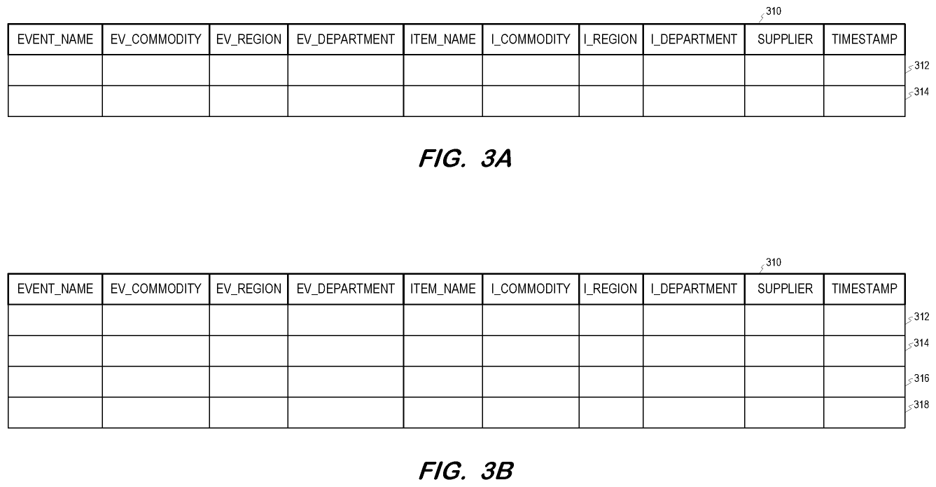

FIG. 3A illustrates a tabular representation of records 310 acquired at S205 according to some embodiments. Embodiments are not limited to the example of FIG. 3A. Each of records 310 includes an Event field and an Item field, and each Event field and each Item field is associated with a respective Commodity, Region and Department field. Each of records 310 also specifies at least one Supplier and a Timestamp. Records 310 therefore represent an event-item pair and a supplier assigned to a given historical sourcing event, as well as a time at which the sourcing event was created.

The fields of a given record 310 may, as described above, be populated with values of fields of a larger record of a larger database table and/or of several records of several database tables stored in data store 114. For example, the fields of records 310 may comprise fields of a larger Sourcing Event database table. In some embodiments, the Event, Item, Supplier and Timestamp fields of each record of records 310 are taken from a same Sourcing Event record and the respective Commodity, Region and Department fields are taken from separate Event and Item records of corresponding Event and Item database tables. In a case that records 310 include supplier attribute fields, these fields may be populated with corresponding values of Supplier records from a Supplier database table.

The plurality of records determined at S205 may be filtered according to any suitable attributes. The filter attributes may be specified by a technical administrator as described above, or by user 120. For example, only records having a timestamp within a specified period may be determined at S205. Or, only records associated with a particular item region may be determined at S205. A model which is trained based on filtered records may provide more accurate inferences in a case that the input to the model satisfies the same filter. Generally, the more similar the training data to the input data during deployment, the more accurate the inferences.

At S210, one or more negative sample records are generated for each of the plurality of records determined at S205. Each of records 310 indicates a “positive” ground truth, in that the supplier(s) of each record is(are) associated with the event-item pair of each record. A negative sample is a record which indicates that the supplier named in the record is not associated with the event-item of the record. By training a model using negative samples as well as positive samples, overfitting to the positive samples can be avoided.

According to some embodiments, a negative sample is generated by adding a record for a given event-item pair which associates the event-item pair with a supplier randomly-selected from a list of known suppliers, while ensuring that the randomly-selected supplier is not already associated with that event-item pair within another record. More than one negative sample may be generated based on a single positive sample by using different suppliers for each negative sample. As shown in FIG. 3B, record 316 may comprise a negative sample corresponding to the event-item pair of record 312, and record 318 may comprise a negative sample corresponding to the event-item pair of record 314.

If the same set of features of an event-item pair are present in a first record and a second record having different timestamps, the suppliers which are present in the first record and not in the second record are used for generating negative samples for the second record and the suppliers which are present in the second record and not in the first record are used for generating negative samples for the first record. If the number of negative samples thusly-generated is not sufficient, regular negative sampling is applied until a threshold number of negative samples is reached.

Each record determined at S205 and generated at S210 is associated with one of a first time period and a second time period. For example, the first time period may comprise a time period which beings in the past and terminates three months before the present date while the second period includes only the three months prior to the present date. The records may be associated with one of the time periods depending on whether the timestamp value of the record falls within the first time period or the second time period. Accordingly, after S215, a first group of records associated with the first time period and a second group of records associated with the second time period are established.

At S220, a model is trained to infer a probability associated with each of a plurality of suppliers from an input event-item pair. The model is trained based on the records associated with the first time period. In this regard, the records associated with the first time period may be considered “training samples” and the records associated with the second time period may be considered “testing samples”. According to some embodiments, records having a more-recent event timestamp are weighted more heavily during training and/or evaluation.

Two records representing different sourcing events from two different time periods may specify the same event-item pair but different suppliers. A negative sample generated based on one of these records might indicate that the supplier of the other record is not associated with the event-item pair. Accordingly, the negative sample would directly contradict the other record and hamper network training or network evaluation based on the records. However, if one of the records is among the training samples associated with the first time period and the other record is among the testing samples associated with the second time period, this contradiction will not present itself during either of network training or network evaluation.

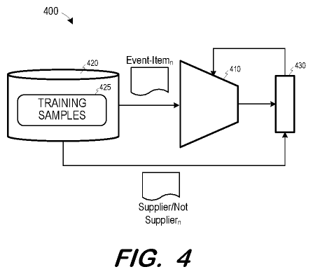

FIG. 4 is a block diagram of training system 400 according to some embodiments. System 400 is utilized to train, or “learn”, node weights of neural network 410 which cause network 410 to infer an output with a desired degree of accuracy. In the present example, network 410 is intended to output a probability associated with each of a plurality of candidate suppliers based on an input event-item pair. Network 410 may therefore be characterized as a classification network.

Broadly, network 410 may comprise a network of neurons which receive input, change internal state according to that input, and produce output depending on the input and internal state. The output of certain neurons is connected to the input of other neurons to form a directed and weighted graph. The weights as well as the functions that compute the internal state can be modified via training as will be described below.

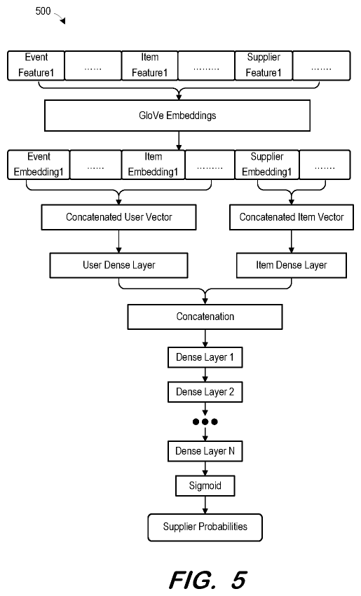

Network 410 may comprise a multi-layer perceptron network, a detailed example of which is provided below with respect to FIG. 5. Network 410 may comprise any one or more types of artificial neural network that are or become known, including but not limited to convolutional neural networks, recurrent neural networks, long short-term memory networks, deep reservoir computing and deep echo state networks, deep belief networks, and deep stacking networks. Network 410 may conform to any network architecture that is or becomes known, including but not limited a multi-network and multi-stage network architectures.

During training at S220 according to some embodiments, an event-item pair of one of n training samples 425 stored in storage 420 is input to network 410. The input may include attributes of either or both of the event and item, depending on the sparsity of such attribute data within training samples 425. Network 410 determines features of the input pair and operates based on its initial node weights to output binary classifications for each of a plurality of suppliers based on the features. Loss layer 430 compares the classifications against the actual supplier information of the current one of n training samples 425. For example, if the current training sample is a positive sample, loss layer 430 compares the supplier classifications against “ground truth” data specifying a supplier which should be indicated in the output classifications as being associated with the event-item pair. Conversely, if the current training sample is a negative sample, loss layer 430 compares the classifications again ground truth data specifying a supplier which should not be indicated in the output classifications as being associated with the event-item pair.

The above process is repeated for each n training sample 425, and loss layer 430 determines a total loss based on all n training samples 425. The function for determining the total loss may comprise any loss function known in the art. The total loss is back-propagated to network 410 in order to modify network 410 in an attempt to minimize the total loss and thereby complete one training iteration. Network 410 is iteratively modified in this manner until the total loss reaches acceptable levels or training otherwise terminates (e.g., due to time constraints or to the loss asymptotically approaching a lower bound).

FIG. 5 is a block diagram of model architecture 500 according to some embodiments. Network 410 of FIG. 4 may comprise an implementation of model architecture 500.

Model architecture 500 is a multi-layer perceptron network. As shown, the inputs to network 500 comprise event attributes (i.e., features) (e.g., name, commodity, region, department), item attributes (i.e., features) (e.g., name, commodity, region, department) and supplier attributes (i.e., features) (e.g., organization, city, state postal code, country). In some embodiments, the supplier attributes include a “was_contracted” flag indicating whether an associated supplier was contracted in the past. The initial layers of architecture 500 extract respective embeddings for each input attribute.

Since the attribute data is expected to consist primarily of textual features, some embodiments do not encode the input data as binarized sparse vectors with one hot encoding. Rather, some embodiments generate Global Vector (GloVe) embeddings (vector representations) for each input attribute using a GloVe unsupervised learning algorithm. Generation of GloVe embeddings is resource-friendly and facilitates fast training and inference.

As shown, the generated event embeddings are concatenated with the generated item embeddings to create a concatenated user vector. Also, the generated supplier embeddings are concatenated to create a concatenated item vector. These vectors are passed through respective dense layers and then concatenated. Latter layers operate as is known in the art to generate final output supplier probabilities.

At S225, the trained model is evaluated based on the records associated with the second time period. If the second time period is more recent than the first time period, and assuming that more-recent records will be more similar to future records than less-recent records, evaluation of the trained model in this manner may provide a better indication of the accuracy and/or precision of the trained model during subsequent deployment thereof.

Evaluation at S225 may consist of inputting the event-item information of the records into the trained model and generating one or more evaluation metrics based on differences between the resulting output and the corresponding supplier information of the records. The metrics may comprise metrics which evaluate a precision and/or a recall of the output classifications, and or any other metrics.

According to some embodiments, the model is evaluated at S225 using Precision@K and Recall@K, where K is the number of recommendations. Precision@K refers to the proportion of the top k recommendations that are relevant. Recall@K is the proportion of the relevant items (here, suppliers) found in the top k recommendations.

The records used during evaluation at S225 may specify suppliers which were not present in the records used to train the model at S220. Accordingly, the metric Recall@K will be 0 in such instances and will therefore providing a misleading evaluation of model performance. To mitigate this effect, evaluation at S225 may be based only on records including suppliers which were in the data associated with the first time period and in which the maximum possible recall is greater than 0. The maximum possible recall for an event-item pair is Recall@N, where N is the total number of suppliers in the training data. That is, if all the suppliers in the training data were to be recommended for every event-item pair, the associated average recall is the maximum possible recall. Alternatively, the apparent error may be discounted to account for suppliers which were not present in the training records.

Based on the evaluation at S225, it is determined at S230 whether the model is satisfactory for use. The determination may consist of a determination of whether the model performance meets pre-established criteria. For example, metrics produced by the evaluation at S225 may be compared with minimum acceptable thresholds. In some embodiments, the model is iteratively trained and the best model is selected from the iteratively-trained models, based on performance criteria.

If the determination at S230 is negative, flow returns to S220 to re-train the model as described above. Re-training may differ from prior training in any known manner, such as by using a different optimization method for iteratively modifying the model node weights, or by shuffling the training samples within the input data batches.

Flow may pause after S230 while waiting to receive an inference request. As described above, an inference request may be received from user 120 during creation of a sourcing event via application 112. For example, user 120 may access a user interface of application 112 via a Web browser and manipulate the user interface to begin creation of a sourcing event. The manipulation may consist of specifying an event and one or more items associated with the event.

According to some embodiments, a neural network model may be trained as described above to recommend one or more questions to associate with a sourcing event. The model may be trained based on historical records including an event-item pair and at least one associated question, and evaluated based on more-recent records including an event-item pair and at least one associated question. Training and evaluation may include the generation of negative samples, as described above with respect to supplier-related data. Embodiments may further provide the user with one or more reasons why a given question has been recommended for a given item.

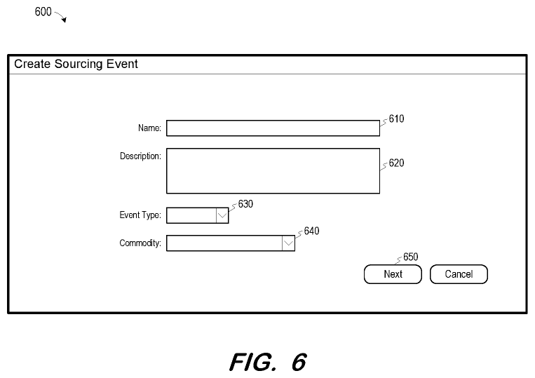

FIG. 6 illustrates user interface 600 of a sourcing application such as application 112 according to some embodiments. User 120 may execute a Web browser to access application 112 via HyperText Transfer Protocol and receive user interface 600 in return.

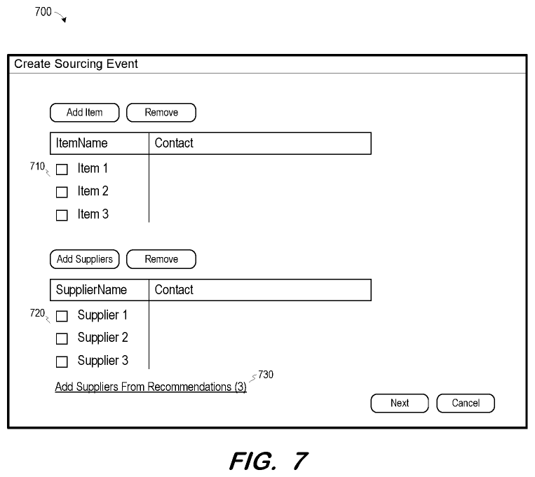

User interface 600 allows a user to initiation creation of a sourcing event. User interface 600 includes input fields 610, 620, 630 and 640 to allow a user to specify, for the Event to be created, a Name, a Description, a Type and a Commodity. Upon selecting Next control 650, the user may be presented with user interface 700 of FIG. 7 for associating items and suppliers with the event.

Area 710 of user interface 700 lists items which may be associated with the event and allows a user to select any of the listed items to be added to the event. Similarly, area 720 of lists suppliers which may be associated with the event and allows the user to select any of the listed suppliers to be added to the event. Any other user interface metaphors may be used to add items or suppliers to an event.

In some embodiments, control 730 appears once one or more items have been added to the event. If selected, control 730 triggers an inference request based on the event and its associated items. This inference request may be received at S240 of process 200.

In response to the inference request, several candidate suppliers are determined from the event-item details of the inference request. An event-item pair is used to find the top few similar event-item pairs in the historical data, which may include both the testing examples and the training examples to ensure that more-recently added events can be reflected in the supplier recommendation. To account for this, all the available records are used to find similar events during inference. The similarity of the event-item pairs may be calculated using a cosine similarity metric based on the event-item embeddings created during the model training. The suppliers associated with those event-item pairs in the training data are then considered as candidate suppliers.

The trained model then outputs a probability for each of the candidate suppliers. If the event of the inference request includes more than one item, each distinct event-item pair is considered a separate inference request. That is, separate supplier probabilities are inferred at S245 for each event-item pair, using the trained network.

At S250 it is determined whether the results should be filtered. In this regard, the user, a technical administrator, developer, or other entity may have configured system 100 to filter out suppliers for which the inferred probability is less than a threshold. In some embodiments, system 100 is configured to filter out all but the top X suppliers ordered by probability. A particular inference request may specify these filters as well as other filters based on supplier attributes (e.g., recommend only suppliers from a given region, providing certain payment terms, providing certain delivery options, etc.).

If no filters are to be applied, flow proceeds to S255 to present the plurality of suppliers to the user based on their respective probabilities. For example, the suppliers may be presented to the user in order of their inferred probabilities. If it is determined at S250 to filter the results, the results are filtered and the remaining suppliers are presented to the user at S260.

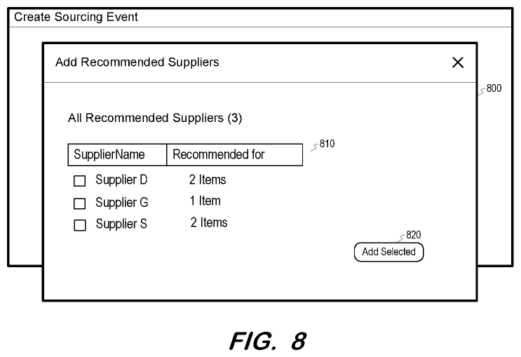

Window 800 of FIG. 8 shows presentation of suppliers at S255 or S260 according to some embodiments. Area 810 shows three presented suppliers, which may be ordered by associated probability. Also shown are the number of items of the event for which each supplier is recommended. In this regard, the event of the present example includes more than one item and a separate inference was performed for each of the items.

According to some embodiments, a user may select one or more of the presented suppliers using the associated checkbox in area 810. The user may then select control 820 to add the selected suppliers to the sourcing event. The selected suppliers may be added to the sourcing event in association with the particular item(s) for which the selected suppliers were recommended.

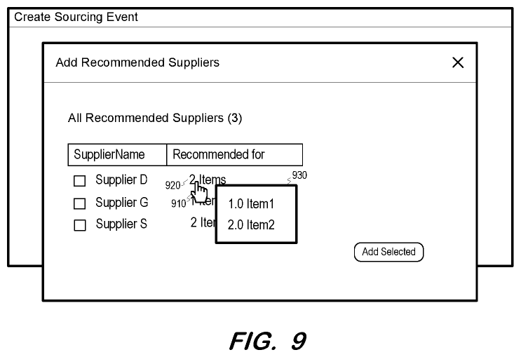

FIG. 9 illustrates placement of cursor 910 over data value 920 according to some embodiments. As shown, pop-up window 930 is displayed in response to hovering cursor 910 over data value 920. Pop-up window 930 provides an indication of the particular items of the event for which Supplier D was recommended.

One or more of the presented suppliers may be selected via control 820 of interface 800. This selection is received at S265. The sourcing event may then be updated with the selected suppliers. Also, at S270, one or more records associated with the current event-item pair(s) and selected suppliers are added to the training data to represent the newly-created sourcing event. According to some embodiments, one or more records associated with the current event-item pair(s) and recommended suppliers who were not selected are added to the training data as corresponding negative records. Flow then returns to S240 to await another inference request.

In parallel, flow proceeds to S275 to determine whether the model is to be retrained. Retraining may be initiated based on a request received from a user or technical administrator, a number of sourcing events created since a last training, a time elapsed since a last training, and/or any other factor. If the model is not to be retrained, flow cycles at S275 until it is determined to retrain the model.

If it is determined at S275 to retrain the model, flow returns to S210 to generate one or more negative samples based on all selected records, including any new records which were not included in prior training data, as well as any suitable portion of the prior training data. Flow then continues as described above to retrain the model based on the positive and negative sample records. The time periods used to segregate the records at S215 may differ from previously-used time periods due to the time elapsed since a last model training. During such retraining, inference requests may continue to be received and fulfilled using the current model as described above.

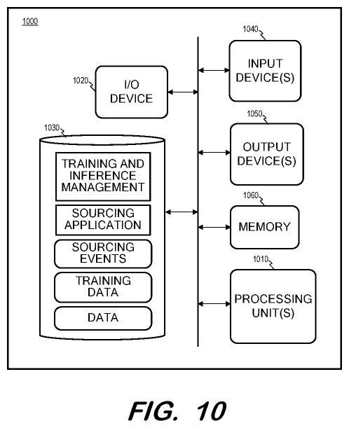

FIG. 10 is a block diagram of a hardware system providing supplier recommendations according to some embodiments. Hardware system 1000 may comprise a general-purpose computing apparatus and may execute program code to perform any of the functions described herein. Hardware system 1000 may be implemented by a distributed cloud-based server and may comprise an implementation of system 100 in some embodiments. Hardware system 1000 may include other unshown elements according to some embodiments.

Hardware system 1000 includes processing unit(s) 1010 operatively coupled to I/O device 1020, data storage device 1030, one or more input devices 1040, one or more output devices 1050 and memory 1060. Communication device 1020 may facilitate communication with external devices, such as an external network, the cloud, or a data storage device. Input device(s) 1040 may comprise, for example, a keyboard, a keypad, a mouse or other pointing device, a microphone, knob or a switch, an infra-red (IR) port, a docking station, and/or a touch screen. Input device(s) 1040 may be used, for example, to enter information into hardware system 1000. Output device(s) 1050 may comprise, for example, a display (e.g., a display screen) a speaker, and/or a printer.

Data storage device 1030 may comprise any appropriate persistent storage device, including combinations of magnetic storage devices (e.g., magnetic tape, hard disk drives and flash memory), optical storage devices, Read Only Memory (ROM) devices, and RAM devices, while memory 1060 may comprise a RAM device.

Data storage device 1030 stores program code executed by processing unit(s) 1010 to cause server 1000 to implement any of the components and execute any one or more of the processes described herein. Embodiments are not limited to execution of these processes by a single computing device. Data storage device 1030 may also store data and other program code for providing additional functionality and/or which are necessary for operation of hardware system 1000, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing processor-executable program code;
a processing unit to execute the processor-executable program code to cause the system to:
determine a plurality of records, each of the plurality of records including an event and event attributes, an item and item attributes, a supplier and supplier attributes, and a timestamp;
for each of the plurality of records, generate a negative sample record including the event and event attributes of the record, the item and item attributes of the record, the timestamp of the record, and a sample supplier and sample supplier attributes different from the supplier and supplier attributes of the record;
associate each of the plurality of records and the generated negative sample records with either a first time period or a second time period based on the timestamp of the record, the second time period occurring after the first period;
train a machine-learning model based on the records and the negative sample records associated with the first time period; and
evaluate the trained model based on the records and the negative sample records associated with the second time period, wherein the evaluation comprises:
determination of records associated with the second time period which include a supplier which is not included in any of the records associated with the first time period; and
determination of a precision metric and a recall metric associated with the trained model.

2. A system according to claim 1, wherein the machine-learning model is a multilayer perceptron network.

3. A system according to claim 2, wherein training the machine-learning model comprises generation of Global Vector embeddings based on each of the event attributes, the item attributes, and the supplier attributes.

4. A system according to claim 1, the processing unit to execute the processor-executable program code to cause the system to:
determine a second plurality of records, each of the second plurality of records including an event and event attributes, an item and item attributes, a supplier and supplier attributes, and a timestamp;
for each of the second plurality of records, generate a negative sample record including the event and event attributes of the record, the item and item attributes of the record, the timestamp of the record, and a sample supplier and sample supplier attributes different from the supplier and supplier attributes of the record;
associate each of the plurality of records, the second plurality of records and the generated negative sample records with either a third time period or a fourth time period based on the timestamp of the record, the fourth time period occurring after third period;
train a second machine-learning model based on the plurality of records, the second plurality of records and the negative sample records associated with the third time period; and
evaluate the trained second model based on the plurality of records, the second plurality of records and the negative sample records associated with the fourth time period, wherein the evaluation comprises:
determination of records associated with the fourth time period which include a supplier which is not included in any of the records associated with the third time period; and
determination of a precision metric and a recall metric associated with the trained second model.

5. A system according to claim 1, the processing unit to execute the processor-executable program code to cause the system to:
input an input event and an input item to the trained model;
execute the model to generate a plurality of candidate suppliers from a plurality of suppliers and a probability for each of the plurality of candidate suppliers based on the input event and the input item;
determine one or more recommended suppliers based on the probabilities; and
present the one or more recommended suppliers.

6. A system according to claim 5, the processing unit to execute the processor-executable program code to cause the system to:
determine one or more recommended suppliers based on the probabilities and on one or more supplier attribute filters.

7. A system according to claim 6, the processing unit to execute the processor-executable program code to cause the system to:
receive a selection of one of the recommended suppliers;
determine a second plurality of records, each of the second plurality of records including an event and event attributes, an item and item attributes, a supplier and supplier attributes, and a timestamp, wherein one of the second plurality of records includes the input event, the input item, and the selected recommended supplier;
for each of the second plurality of records, generate a negative sample record including the event and event attributes of the record, the item and item attributes of the record, the timestamp of the record, and a sample supplier and sample supplier attributes different from the supplier and supplier attributes of the record;
associate each of the plurality of records, the second plurality of records and the generated negative sample records with either a third time period or a fourth time period based on the timestamp of the record, the fourth time period occurring after third period;
train a second machine-learning model based on the plurality of records, the second plurality of records and the negative sample records associated with the third time period; and
evaluate the trained second model based on the plurality of records, the second plurality of records and the negative sample records associated with the fourth time period, wherein the evaluation comprises:
determination of records associated with the fourth time period which include a supplier which is not included in any of the records associated with the third time period; and
determination of a precision metric and a recall metric associated with the trained second model.

8. A method comprising:
determining a plurality of records, each of the plurality of records including an event, an item, a supplier, and a timestamp;
for each of the plurality of records, generating a negative sample record including the event of the record, the item of the record, the timestamp of the record, and a sample supplier different from the supplier of the record;
associating each of the plurality of records and the generated negative sample records with either a first time period or a second time period based on the timestamp of the record, the second time period occurring after the first period;
training a machine-learning model based on the records and the negative sample records associated with the first time period; and
evaluating the trained model based on the records and the negative sample records associated with the second time period, wherein the evaluation comprises:
determining records associated with the second time period which include a supplier which is not included in any of the records associated with the first time period; and
determining a precision metric and a recall metric associated with the trained model.

9. A method according to claim 8, wherein the machine-learning model is a multilayer perceptron network.

10. A method according to claim 8, comprising:
determining a second plurality of records, each of the second plurality of records including an event, an item, a supplier, and a timestamp;
for each of the second plurality of records, generating a negative sample record including the event of the record, the item of the record, the timestamp of the record, and a sample supplier different from the supplier and supplier attributes of the record;
associating each of the plurality of records, the second plurality of records and the generated negative sample records with either a third time period or a fourth time period based on the timestamp of the record, the fourth time period occurring after third period;
training a second machine-learning model based on the plurality of records, the second plurality of records and the negative sample records associated with the third time period; and
evaluating the trained second model based on the plurality of records, the second plurality of records and the negative sample records associated with the fourth time period, wherein the evaluation comprises:
determining records associated with the fourth time period which include a supplier which is not included in any of the records associated with the third time period; and
determining a precision metric and a recall metric associated with the trained second model.

11. A method according to claim 8, comprising:
inputting an input event and an input item to the trained model;
executing the model to generate a plurality of candidate suppliers from a plurality of suppliers and a probability for each of the plurality of candidate suppliers based on the input event and the input item;
determining one or more recommended suppliers based on the probabilities; and
presenting the one or more recommended suppliers.

12. A method according to claim 11, comprising:
determining one or more recommended suppliers based on the probabilities and on one or more supplier attribute filters.

13. A method according to claim 12, comprising:
receiving a selection of one of the recommended suppliers;
determining a second plurality of records, each of the second plurality of records including an event, an item, a supplier, and a timestamp, wherein one of the second plurality of records includes the input event, the input item, and the selected recommended supplier;
for each of the second plurality of records, generating a negative sample record including the event of the record, the item of the record, the timestamp of the record, and a sample supplier different from the supplier of the record;
associating each of the plurality of records, the second plurality of records and the generated negative sample records with either a third time period or a fourth time period based on the timestamp of the record, the fourth time period occurring after third period;
training a second machine-learning model based on the plurality of records, the second plurality of records and the negative sample records associated with the third time period; and
evaluating the trained second model based on the plurality of records, the second plurality of records and the negative sample records associated with the fourth time period, wherein the evaluation comprises:
determining records associated with the fourth time period which include a supplier which is not included in any of the records associated with the third time period; and
determining a precision metric and a recall metric associated with the trained second model.

14. A non-transitory medium storing processor-executable program code executable by a processing unit of a computing system to cause the computing system to:
determine a plurality of records, each of the plurality of records including an event and event attributes, an item and item attributes, a supplier and supplier attributes, and a timestamp;
for each of the plurality of records, generate a negative sample record including the event and event attributes of the record, the item and item attributes of the record, the timestamp of the record, and a sample supplier and sample supplier attributes different from the supplier and supplier attributes of the record;
associate each of the plurality of records and the generated negative sample records with either a first time period or a second time period based on the timestamp of the record, the second time period occurring after the first period;
train a machine-learning model based on the records and the negative sample records associated with the first time period; and
evaluate the trained model based on the records and the negative sample records associated with the second time period, wherein the evaluation comprises:
determination of records associated with the second time period which include a supplier which is not included in any of the records associated with the first time period; and
determination of a precision metric and a recall metric associated with the trained model.

15. A medium according to claim 14, wherein the machine-learning model is a multilayer perceptron network.

16. A medium according to claim 15, wherein training the machine-learning model comprises generation of Global Vector embeddings based on each of the event attributes, the item attributes, and the supplier attributes.

17. A medium according to claim 14, the processor-executable program code executable by a processing unit of a computing system to cause the computing system to:
determine a second plurality of records, each of the second plurality of records including an event and event attributes, an item and item attributes, a supplier and supplier attributes, and a timestamp;
for each of the second plurality of records, generate a negative sample record including the event and event attributes of the record, the item and item attributes of the record, the timestamp of the record, and a sample supplier and sample supplier attributes different from the supplier and supplier attributes of the record;
associate each of the plurality of records, the second plurality of records and the generated negative sample records with either a third time period or a fourth time period based on the timestamp of the record, the fourth time period occurring after third period;
train a second machine-learning model based on the plurality of records, the second plurality of records and the negative sample records associated with the third time period; and
evaluate the trained second model based on the plurality of records, the second plurality of records and the negative sample records associated with the fourth time period, wherein the evaluation comprises:
determination of records associated with the fourth time period which include a supplier which is not included in any of the records associated with the third time period; and
determination of a precision metric and a recall metric associated with the trained second model.

18. A medium according to claim 14, the processor-executable program code executable by a processing unit of a computing system to cause the computing system to:
input an input event and an input item to the trained model;
execute the model to generate a plurality of candidate suppliers from a plurality of suppliers and a probability for each of the plurality of candidate suppliers based on the input event and the input item;
determine one or more recommended suppliers based on the probabilities; and
present the one or more recommended suppliers.

19. A medium according to claim 18, the processor-executable program code executable by a processing unit of a computing system to cause the computing system to:
determine one or more recommended suppliers based on the probabilities and on one or more supplier attribute filters.

20. A medium according to claim 19, the processor-executable program code executable by a processing unit of a computing system to cause the computing system to:
receive a selection of one of the recommended suppliers;
determine a second plurality of records, each of the second plurality of records including an event and event attributes, an item and item attributes, a supplier and supplier attributes, and a timestamp, wherein one of the second plurality of records includes the input event, the input item, and the selected recommended supplier;
for each of the second plurality of records, generate a negative sample record including the event and event attributes of the record, the item and item attributes of the record, the timestamp of the record, and a sample supplier and sample supplier attributes different from the supplier and supplier attributes of the record;
associate each of the plurality of records, the second plurality of records and the generated negative sample records with either a third time period or a fourth time period based on the timestamp of the record, the fourth time period occurring after third period;
train a second machine-learning model based on the plurality of records, the second plurality of records and the negative sample records associated with the third time period; and
evaluate the trained second model based on the plurality of records, the second plurality of records and the negative sample records associated with the fourth time period, wherein the evaluation comprises:
determination of records associated with the fourth time period which include a supplier which is not included in any of the records associated with the third time period; and
determination of a precision metric and a recall metric associated with the trained second model.
